(19) United States
(12) Patent Application Publication
(10) Pub. No.: US 2017/0197721 A1
(43) Pub. Date: Jul. 13, 2017

(54) IN-FLIGHT BEVERAGE HOLDER DEVICE AND METHOD

(71) Applicants: Ingrid Ellis, Weehawken, NJ (US); Noah Ellis, Weehawken, NJ (US)

(72) Inventors: Ingrid Ellis, Weehawken, NJ (US); Noah Ellis, Weehawken, NJ (US)

(21) Appl. No.: 15/405,306

(22) Filed: Jan. 13, 2017

Related U.S. Application Data
(60) Provisional application No. 62/278,036, filed on Jan. 13, 2016.

(51) Int. Cl. B64D 11/06; A47G 23/02

(52) U.S. Cl. CPC B64D 11/0638; A47G 23/0225; A47G 2400/02

(57) ABSTRACT

A beverage holder device including an expandable pouch, and at least one attachment device. The expandable pouch including an opening facing upwards, and configured to circumscribe and support a beverage container in an upright position. The at least one attachment device affixed to the expandable pouch at the opening of the expandable pouch, with the at least one attachment device configured to removably couple the expandable pouch to an object.

### CROSS-REFERENCE TO RELATED APPLICATION

The present application is related to and claims priority to U.S. Provisional Patent Application No. 62/278,036 filed Jan. 13, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

1. Field of the Invention

The present invention relates generally to the field of chairs and seats of the existing art and more specifically relates to package and article carriers.

2. Description of Related Art

Anyone who has flown on a commercial flight before knows how difficult it can be to carry a beverage onto an airplane. The only cup holder provided by an airline may be the tiny indentation on a tray table, which is not available for use during takeoffs and landing, as the tray table is required to be in the up and locked position at such times. Also, any moderate turbulence or movement from the person in the seat in front can cause the beverage to tip and/or spill.

Some individuals may choose to hold a beverage between their legs or in the hand, but this can lead to the beverage spilling on that person, the neighbor, or even the personal property, such as a laptop and/or luggage stored beneath a seat. A suitable solution is desired.

U.S. Pat. No. 5,529,228 to Matthew Biagi relates to a mesh liquid container carrier. The described mesh liquid container includes a mesh joined together to hold a liquid container while the area of mesh not joined creates a loop that can be used as a strap to be worn around the body of an individual. The length of the longitudinal embodiment of the mesh that does not hold the liquid container can be tied in a knot at any area adjusting the length of the strap.

### BRIEF SUMMARY OF THE INVENTION

In view of the foregoing disadvantages inherent in the known package and article carrier art, the present disclosure provides a novel beverage holder device and method. The general purpose of the present disclosure, which will be described subsequently in greater detail, is to provide a beverage holder device and method.

A beverage holder device is disclosed herein, in embodiments. The beverage holder device includes an expandable pouch, and at least one attachment device. In an embodiment, the expandable pouch includes an opening facing upwards configured to circumscribe and support a beverage container in an upright position.

The at least one attachment device is affixed to the expandable pouch at the opening of the expandable pouch, with the at least one attachment device configured to removably couple the expandable pouch to an object, in certain embodiments.

In some embodiments, the attachment device is removably affixed to the beverage holder device, and the attachment device includes a removable, flexible metal band that is configured to wrap around the object. The expandable pouch is preferably comprised entirely of a mesh opening which is elliptically shaped and constructed from an anti-fungal material for improved hygiene. Also, the expandable pouch is constructed from a fabric, in some embodiments.

A brim contained within the opening, comprises a solid annular material configured to maintain a predetermined shape of the opening, with the brim being removable from the expandable pouch, in embodiments.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a beverage holder device, constructed and operative according to the teachings of the present disclosure.

FIG. 1 is a perspective view of the beverage holder device during an ‘in-use’ condition, according to an embodiment of the disclosure.

FIG. 2 is a right side view of the beverage holder device of FIG. 1, according to an embodiment of the present disclosure.

FIG. 3 is a left side view of the beverage holder device of FIG. 1, according to an embodiment of the present disclosure.

FIG. 4 is a perspective view of the beverage holder device of FIG. 1, according to an embodiment of the present disclosure.

FIG. 5 is a perspective view of the beverage holder device of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to package and article carriers, and more particularly to a beverage holder device as used to improve the secure holding of a beverage container to an object by providing a device that can accommodate a wide variety of shapes and sizes of beverage containers while remaining removable from the (host) object.

Generally, beverage holder can constructed with an expandable material which is capable of holding both hot or cold drinks of almost any size (e.g., depth, height, width, etc.). The opening of the device can be slightly slouchy, which allows the unit to lay flush when attached to an object but not in use (i.e., not holding a beverage container).

The opening may also include a brim, where the brim may include a solid material to maintain shape, or elastic to grip the beverage container. The beverage holder may be securely fastened to the back of the armrest of the seat of the passenger directly in front a traveler/user inside of an airplane. Once the traveler/user decides to use the holder, he/she simply slides the drink into the mouth of the unit to contain and hold the beverage container.

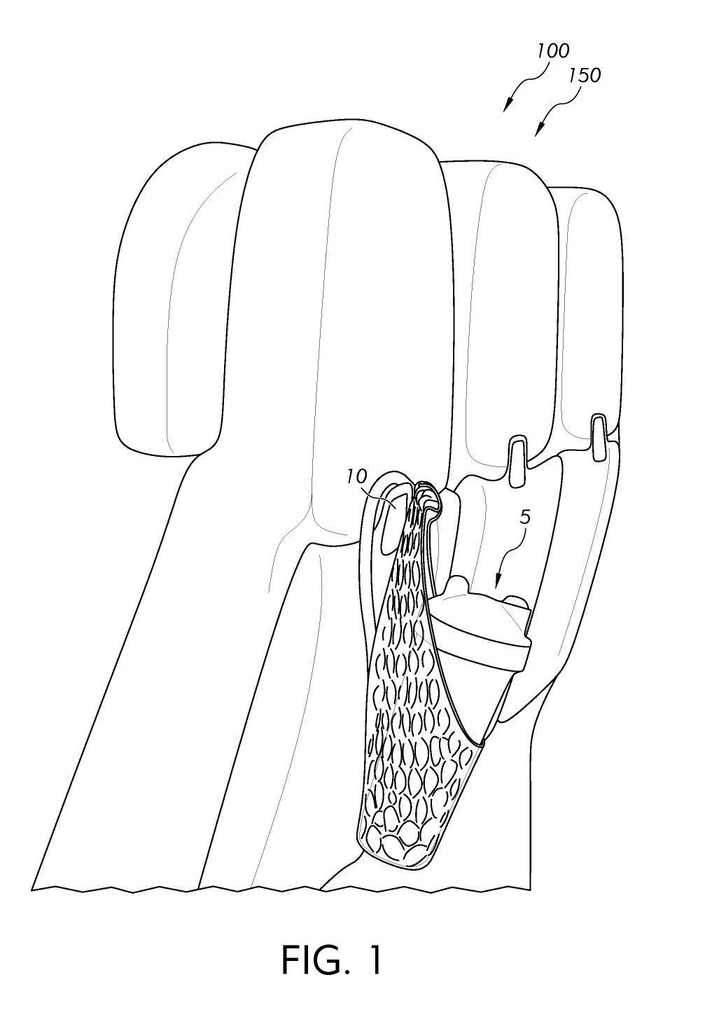

Referring now more specifically to the drawings by numerals of reference, there is shown in FIGS. 1-4, various views of a beverage holder device 100. FIG. 1 shows a beverage holder device 100 during an ‘in-use’ condition 150, according to an embodiment of the present disclosure. Here, the beverage holder device 100 may be beneficial for use by a user to hold, support and carry a beverage container 100 removably to object 10. As illustrated, the beverage holder device 100 may include expandable pouch 110, and at least one attachment device 120.

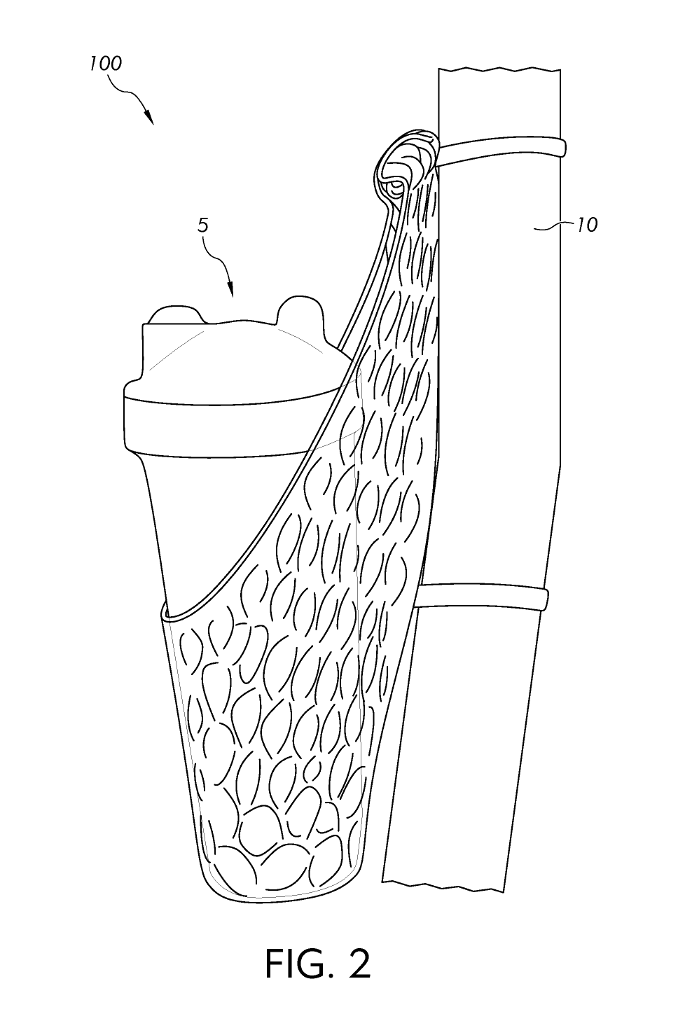

FIG. 1 and FIG. 2 illustrate expandable pouch 110 which may include opening 112 facing upwards and configured to circumscribe and support beverage container 5 in an upright position. At least one attachment device 120 may affix to expandable pouch 110 to opening 112, at least one attachment device 120 may be configured to removably couple expandable pouch 110 to object 10.

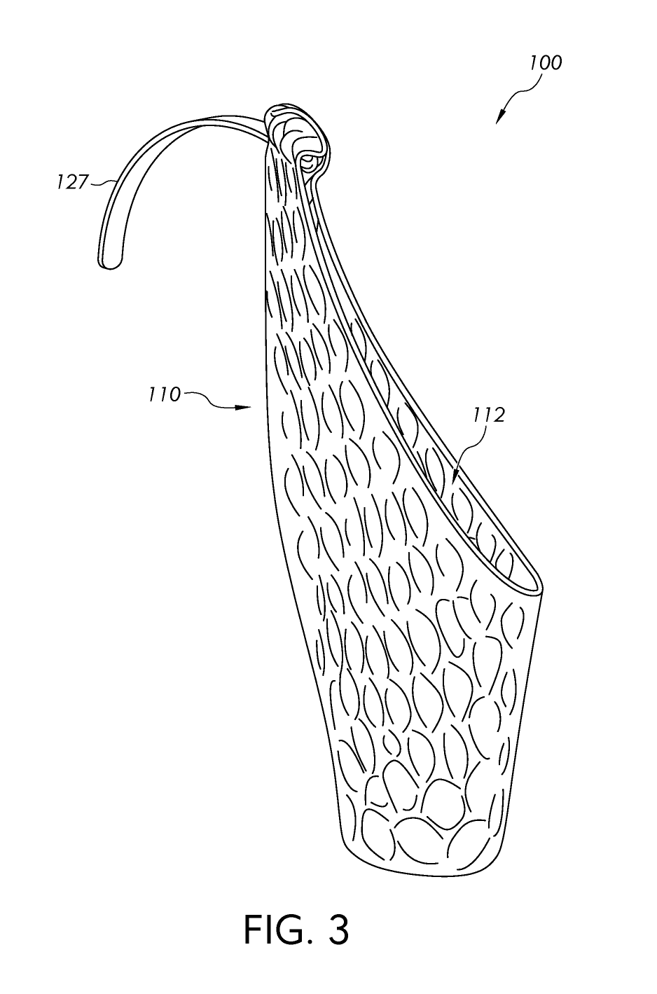

FIG. 3 is a left side view of the beverage holder device 100, according to an embodiment of the present disclosure. As shown, beverage holder device 100 may include expandable pouch 110 comprised entirely of a mesh. Also shown, opening 112 may be elliptically shaped, in some embodiments. In other embodiments, opening 112 may comprise alternate shapes (e.g., round, ellipse, square, etc.).

Expandable pouch 110 may be constructed from an anti-fungal material for improved hygiene. Also, expandable pouch 110 may be constructed from a fabric, and expandable pouch 110 may be constructed from a continuous material configured to contain leakage from beverage container 5, in some embodiments.

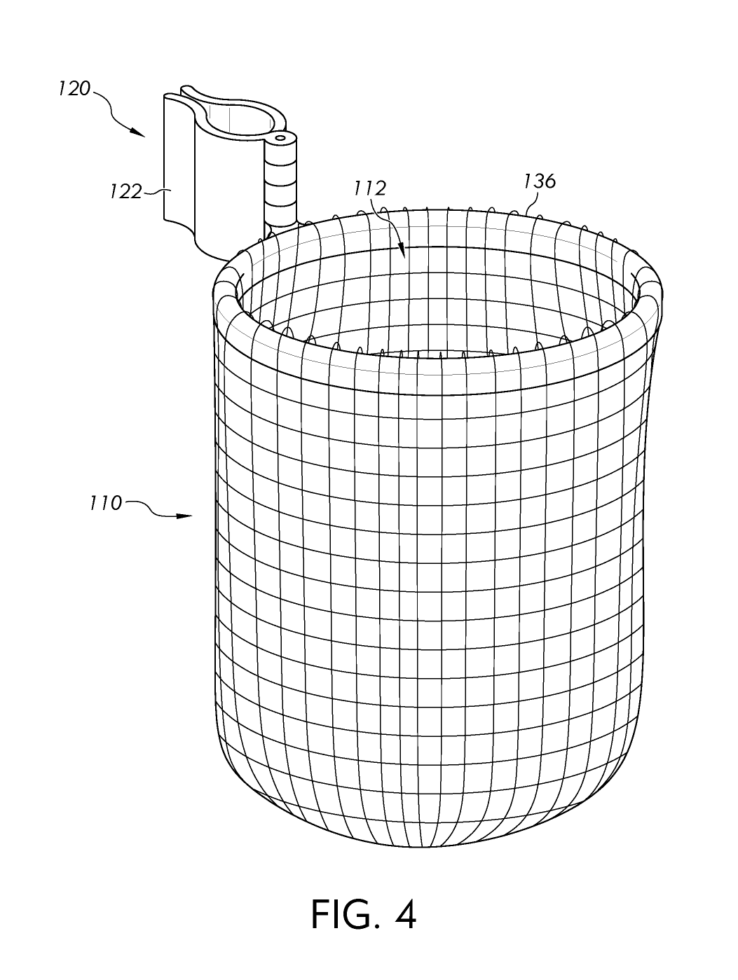

FIG. 4 is a perspective view of the beverage holder device 100, according to an embodiment of the present disclosure. As shown, beverage holder device 100 may comprise brim 136. Brim 136 may comprises a solid annular material configured to maintain a predetermined shape of opening 112, in some embodiments. Also, brim 136 may comprise an elastic material configured frictionally grip beverage container 5. Some embodiments may include brim 136 which may be removable from expandable pouch 110.

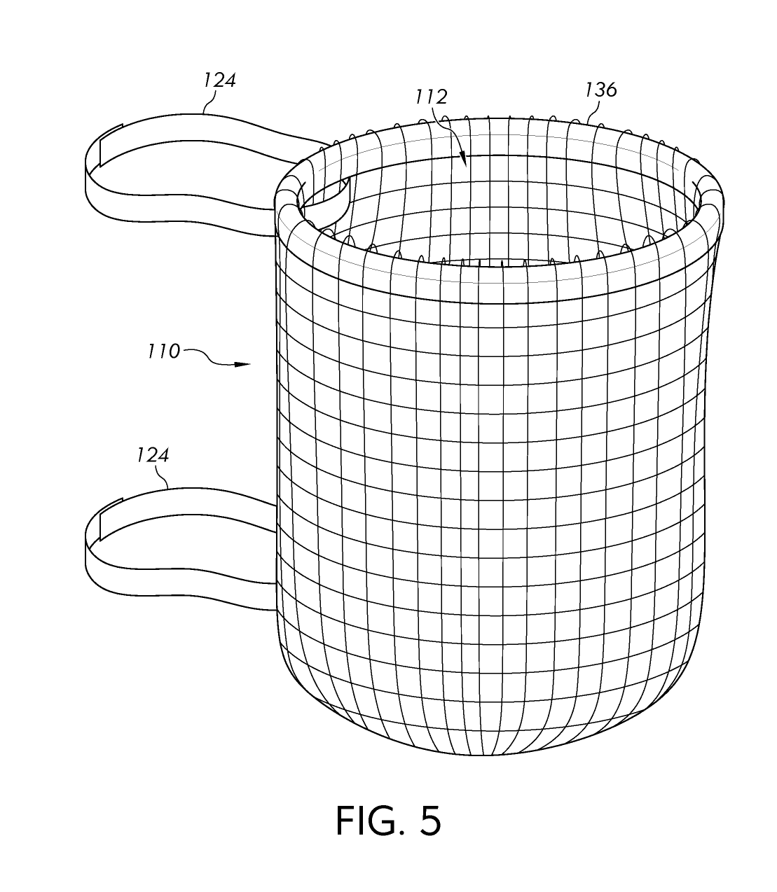

Referring now to FIG. 5 a perspective view of the beverage holder device 100, according to an embodiment of the present disclosure. Shown is attachment device 120 which may comprise hook-and-loop fastener 124 configured to removably secure beverage holder device 100 to object 10.

Attachment device 120 may removably affixed to beverage holder device 100 in some embodiments such that attachment device 120 may be removed and replaced as needed. Attachment device 120 may include a removable, flexible metal band configured to wrap around object 10, clamp 122 configured to removably secure beverage holder device 100 to object 10, loop 126 configured to hang expandable pouch 110 from object 10, and/or hook 127 configured to removably secure beverage holder device 100 to object 10, in select embodiments. Attachment device 120 may comprise clamp 122, in embodiments.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A beverage holder device, the beverage holder device comprising:
an expandable pouch, the expandable pouch including an opening facing upwards and configured to circumscribe and support a beverage container in an upright position; and
at least one attachment device affixed to the expandable pouch at the opening, the at least one attachment device configured to removably couple the expandable pouch to an object.

2. The beverage holder device of claim 1, wherein the expandable pouch is comprised entirely of a mesh.

3. The beverage holder device of claim 1, wherein the opening is elliptically shaped.

4. The beverage holder device of claim 1, further comprising a brim contained within the opening.

5. The beverage holder device of claim 4, wherein the brim comprises a solid annular material configured to maintain a predetermined shape of the opening.

6. The beverage holder device of claim 4, wherein the brim comprises an elastic material configured frictionally grip the beverage container.

7. The beverage holder device of claim 4, wherein the brim is removable from the expandable pouch.

8. The beverage holder device of claim 1, wherein the attachment device is removably affixed to beverage holder device.

9. The beverage holder device of claim 1, wherein the attachment device includes a removable, flexible, metal band configured to wrap around the object.

10. The beverage holder device of claim 1, wherein the attachment device includes a clamp configured to removably secure the beverage holder device to the object.

11. The beverage holder device of claim 1, wherein the attachment device comprises a hook-and-loop fastener configured to removably secure the beverage holder device to the object.

12. The beverage holder device of claim 1, wherein the attachment device comprises a loop configured to hang the expandable pouch from the object.

13. The beverage holder device of claim 1, wherein the attachment device comprises a hook configured to removably secure the beverage holder device to the object.

14. The beverage holder device of claim 1, wherein the attachment device is a clamp.

15. The beverage holder device of claim 1, wherein the expandable pouch is constructed from an anti-fungal material for improved hygiene.

16. The beverage holder device of claim 1, wherein the expandable pouch is constructed from a fabric.

17. The beverage holder device of claim 1, wherein the expandable pouch is constructed from a continuous material configured to contain leakage from the beverage container.

18. A beverage holder device, the beverage holder device comprising:
an expandable pouch, the expandable pouch including an opening facing upwards and configured to circumscribe and support a beverage container in an upright position with the opening being elliptically shaped, the expandable pouch constructed from an anti-fungal material for improved hygiene, the expandable pouch comprised of a mesh;
at least one attachment device affixed to the expandable pouch at the opening, the at least one attachment device configured to removably couple the expandable pouch to an object, the attachment device removably affixed to beverage holder device, the attachment device comprising a clamp; and
a brim contained within the opening, the brim comprising an elastic material configured frictionally grip the beverage container, the brim removable from the expandable pouch.

19. A beverage holder device, the beverage holder device comprising:
an expandable pouch, the expandable pouch including an opening facing upwards and configured to circumscribe and support a beverage container in an upright position with the opening being elliptically shaped, the expandable pouch constructed from an anti-fungal material for improved hygiene, the expandable pouch comprised of a mesh;
at least one attachment device affixed to the expandable pouch at the opening, the at least one attachment device configured to removably couple the expandable pouch to an object, the attachment device removably affixed to beverage holder device, the attachment device comprising a hook-and-loop fastener; and
a brim contained within the opening, the brim comprising an elastic material configured frictionally grip the beverage container, the brim removable from the expandable pouch.
